(19) United States
(12) Patent Application Publication
(10) Pub. No.: US 2013/0147723 A1
(43) Pub. Date: Jun. 13, 2013

(54) HEATING, VENTILATION AND AIR CONDITIONING SYSTEM USER INTERFACE HAVING AN INTEGRATED SCREEN/HOUSING SKIN AND METHOD OF OPERATION THEREOF

(71) Applicants: Larry S. Bias, Prosper, TX (US); Daniel Castillo, Plano, TX (US); Bobby Difulgentiz, Frisco, TX (US); Gabaza B. Mlambo, McKinney, TX (US); Stephen J. Vendt, Little Elm, TX (US)

(72) Inventors: Larry S. Bias, Prosper, TX (US); Daniel Castillo, Plano, TX (US); Bobby Difulgentiz, Frisco, TX (US); Gabaza B. Mlambo, McKinney, TX (US); Stephen J. Vendt, Little Elm, TX (US)

(21) Appl. No.: 13/432,574

(22) Filed: Mar. 28, 2012

Related U.S. Application Data
(60) Provisional application No. 61/569,859, filed on Dec. 13, 2011.

(51) Int. Cl. G06F 3/041

(52) U.S. Cl. 345/173

(57) ABSTRACT

A user interface for use with an HVAC system, a method of providing an integrated screen/housing skin for a user interface of an HVAC system and an HVAC system incorporating the user interface or the method. In one embodiment, the user interface includes: (1) a display configured to provide information to a user, (2) a housing skin at least partially surrounding the display and (3) a processor and memory coupled to the display and the touchpad and configured to drive the display, the display further configured alternatively to display a first screen containing information regarding the HVAC system and a second screen that matches the housing skin such that the housing skin and the second screen appear to form a cohesive image.

### CROSS-REFERENCE TO RELATED APPLICATION

This application claims the benefit of U.S. Provisional application Ser. No. 61/569,859, filed by Bias, et al., on Dec. 13, 2011, entitled “Heating, Ventilation and Air Conditioning System User Interface Having One or More of One-Touch Away Feature, Adjustable Fonts, Proportional Animation Graphics, Service Reminders on a Single Screen, Separate Programming and Manual Mode Screens, Integrated Screen/Housing Skin, Low-Profile Housing, Secure Functional Upgrade Feature and Remote Platform Access Application Associated Therewith,” commonly assigned with this application and incorporated herein by reference.

### TECHNICAL FIELD

This application is directed, in general, to a heating, ventilation and air conditioning (HVAC) systems and, more specifically, to an HVAC system having a user interface, such as a thermostat.

### BACKGROUND

Users interact with HVAC systems through user interfaces. The most common user interface employed today is the thermostat. The most basic thermostats feature one or more dials, switches or levers and allow users to set temperatures. More elaborate thermostats feature a liquid crystal display (LCD) screen, perhaps even of the touchscreen variety, and allow users to program their HVAC systems for automatic temperature settings, configure and maintain their HVAC systems and records of historical operation data, allowing the users to gauge the performance and efficiency of their HVAC systems.

Thermostats necessarily include both temperature sensors and control circuitry within their housings. Some user interfaces do not qualify as thermostats, because while they communicate with temperature sensors and control circuitry, they do not include both within their housings.

### SUMMARY

One aspect provides a user interface. In one embodiment, the user interface includes: (1) a display configured to provide information to a user, (2) a housing skin at least partially surrounding the display and (3) a processor and memory coupled to the display and the touchpad and configured to drive the display, the display further configured alternatively to display a first screen containing information regarding the HVAC system and a second screen that matches the housing skin such that the housing skin and the second screen appear to form a cohesive image.

Another aspect provides a method of providing an integrated screen/housing skin for a user interface of an HVAC system. In one embodiment, the method includes: (1) causing a housing skin at least partially to surround a display of the user interface, (2) displaying a first screen on a display of the user interface that contains information regarding the HVAC system and (3) alternatively displaying a second screen on the display that matches the housing skin such that the housing skin and the second screen appear to form a cohesive image.

Yet another aspect provides an HVAC system. In one embodiment, the HVAC system includes: (1) a heat pump or a compressor having at least one stage, (2) at least one condenser coil, (3) an expansion valve, (4) at least one evaporator coil, (5) a loop of pipe interconnecting the heat pump or compressor, the at least one condenser coil, the expansion valve and the at least one evaporator coil and containing a refrigerant, (6) at least one fan configured to cause outdoor air and indoor air to blow over the at least one condenser coil and the least one evaporator coil and (7) a user interface, including: (7a) a display configured to provide information to a user, (7b) a housing skin at least partially surrounding the display and (7c) a processor and memory coupled to the display and the touchpad and configured to drive the display, the display further configured alternatively to display a first screen containing information regarding the HVAC system and a second screen that matches the housing skin such that the housing skin and the second screen appear to form a cohesive image.

### BRIEF DESCRIPTION

Reference is now made to the following descriptions taken in conjunction with the accompanying drawings, in which:

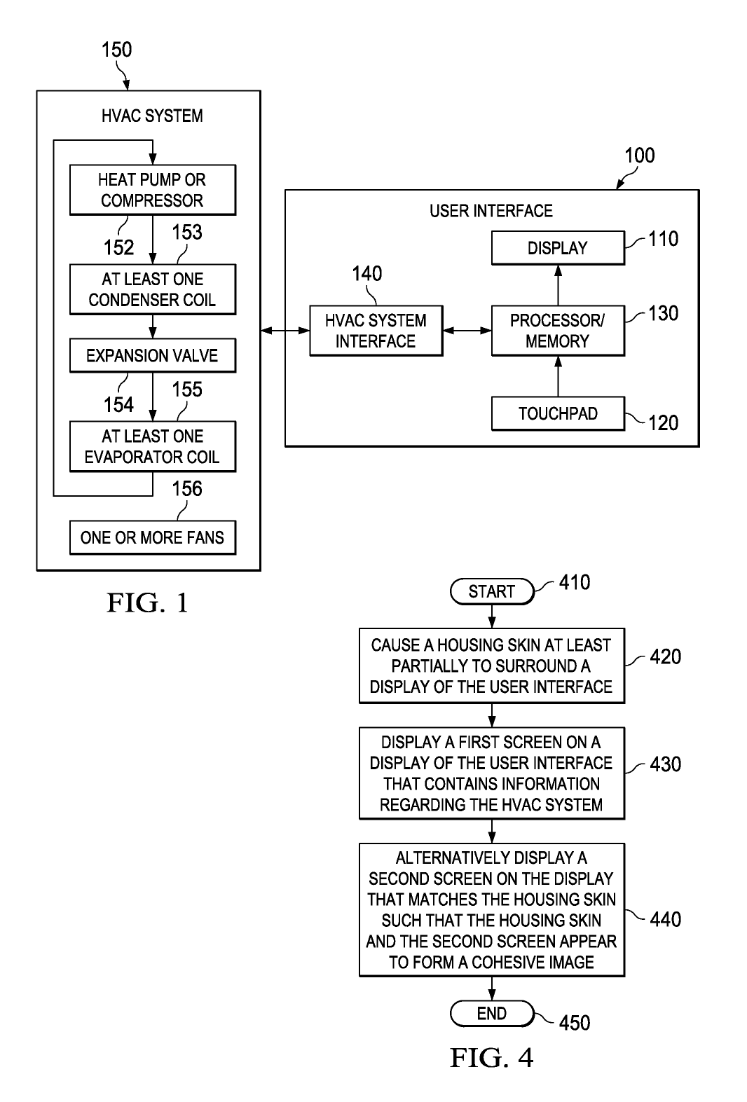

FIG. 1 is a block diagram of one embodiment of a user interface;

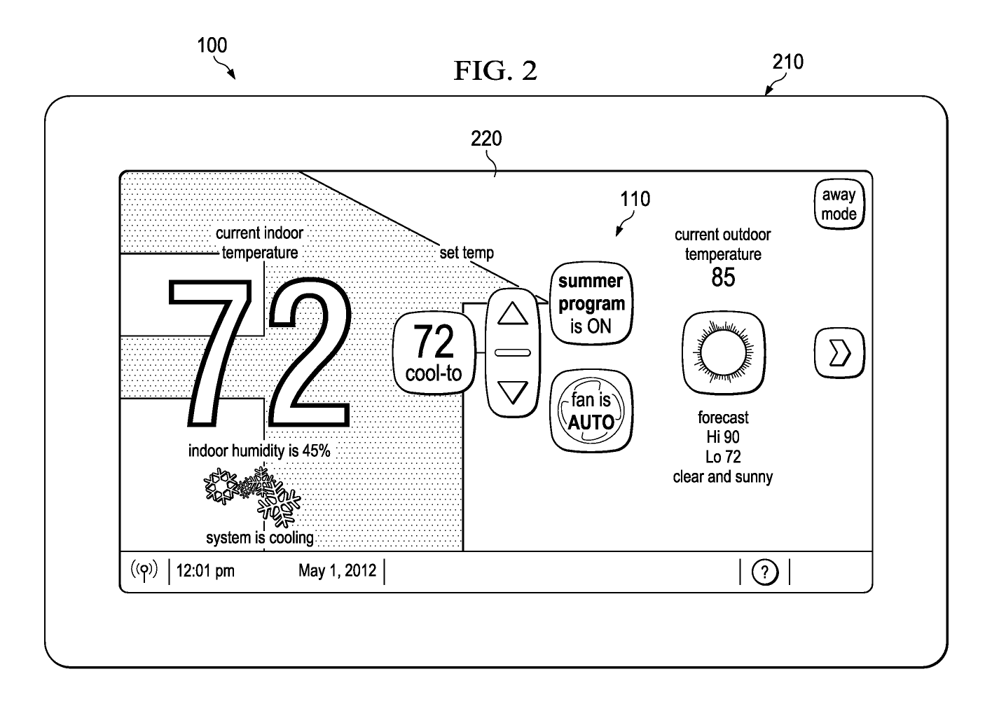

FIG. 2 is a front-side elevational view of one embodiment of a user interface;

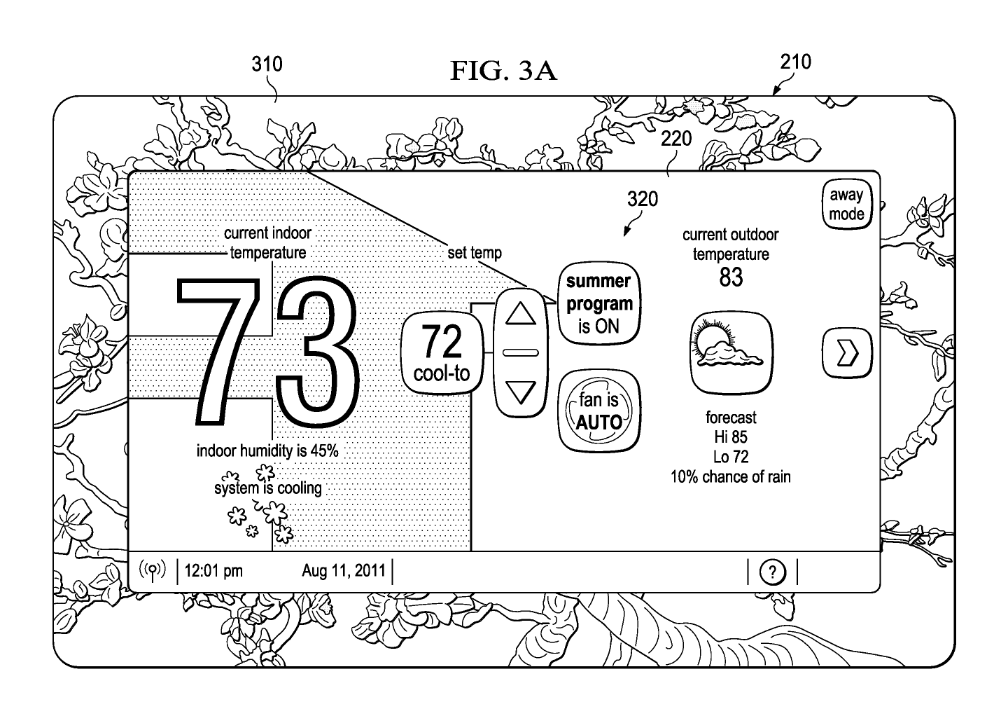

FIGS. 3A and 3B are front-side elevational views of the user interface of FIG. 2 having an integrated screen/housing skin displayed and overlaid thereon; and

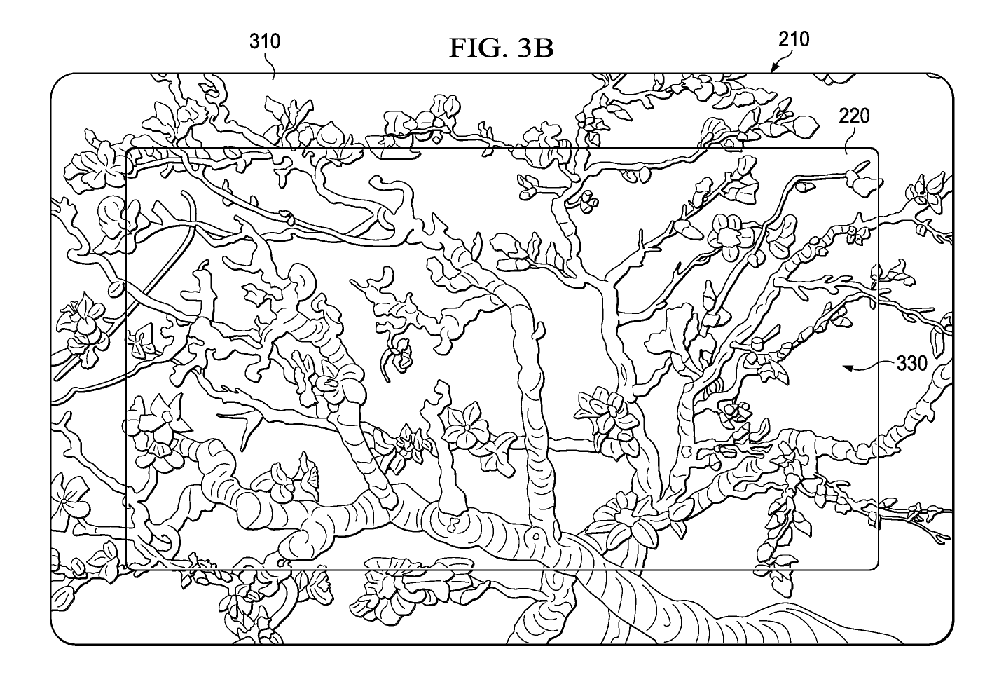

FIG. 4 is a flow diagram of one embodiment of a method of providing an integrated screen/housing skin.

### DETAILED DESCRIPTION

FIG. 1 is a block diagram of one embodiment of a user interface 100. The interface has a display 110 and a touchpad 120. The display 110 is configured to provide information to a user, and the touchpad 120 is configured to accept input from a user. A processor and memory 130 are coupled to the display 110 and the touchpad 120 to drive the display 110 and process the input from the touchpad 120. More accurately, software or firmware is loaded into and stored in the memory and, when executed in the processor, configures the processor to drive the display 110 and process the input from the touchpad 120. An HVAC system interface 140 is coupled to the processor and memory 130 and is configured to provide communication between the processor and memory 130 and the remainder of an HVAC system 150. In various embodiments, the HVAC system 150 includes one or more loops of pipe (one being shown and referenced as 151) containing a refrigerant. Each loop transports the refrigerant among a heat pump or a compressor 152 having at least one stage, at least one condenser coil 153, an expansion valve 154 and at least one evaporator coil 155. One or more fans (“blowers”) 156 cause outdoor air and indoor air to blow over the at least one condenser coil 153 and the at least one evaporator coil 155 to transfer heat to or from them. Those skilled in the pertinent art are familiar with conventional HVAC systems and generally understand the many embodiments and forms they may take.

FIG. 2 is a front-side elevational view of one embodiment of the user interface of FIG. 1. The user interface 100 has a bezel 210. The display 110 is configured to display at least one screen 220 of information for the benefit of a user (the term also including an installer or any other person interested in gaining information from the user interface 100).

Although unreferenced, the screen 220 shown in FIG. 2 includes a current temperature display portion, a setpoint temperature display portion, buttons to raise or lower the setpoint temperature, a system mode message display portion (i.e., “system is heating”) and a program status message display portion (i.e., “program is on”). The screen 220 also has current date and time display portions and allows the user to display other screens (via a “press for more” message).

FIGS. 3A and 3B are front-side elevational views of the user interface of FIG. 2 having an integrated screen/housing skin displayed and overlaid thereon.

The integrated screen/housing skin addresses the problem some users have with the appearance of their user interfaces. Conventional user interfaces are conspicuous on most walls, especially those with a pattern. This feature provides a way for the user interface to blend into a wall or become a work of art or a favorite pattern of a consumer. The user interface of FIG. 3A shows a housing skin 310 that covers the bezel 210. The display 220 shows a typical screen (a “first screen”) 320 (e.g., a home screen) containing information regarding the HVAC system. The user interface of FIG. 3B shows the same housing skin 310 that covers the bezel 210. However, an alternative, second screen 330 of FIG. 3B matches the housing skin such that the housing skin 310 and the second screen 330 appear to form an uninterrupted, cohesive image. In one embodiment, the image or pattern also matches a wall pattern (not shown), allowing the user interface to blend into the wall. The wall pattern may be one of texture (e.g., formed by conventional wall compound, spackle or perlite fines applied before or during painting) or color (e.g., formed by multiple paint colors or wallpaper). In the illustrated embodiment, the pattern of the housing skin 310 registers (aligns) with the pattern on the screen 320 both horizontally and vertically.

In various embodiments, this feature allows a user to match walls and personalization. One or more housing skins 310 and matching pictures may be provided (e.g., purchased) as an HVAC user interface customization kit. Users can purchase a housing skin 310 for the bezel 210 and download or upload a matching picture to act as a second screen 330 for the display 220. The picture may then be transferred to the user interface. A corresponding housing skin 310 may be adhesively bonded to the bezel 210 of the user interface. In one embodiment, the housing skin 310 is composed of adhesive-backed vinyl. In another embodiment, the adhesive is such that a user can remove and repositionthe housing skin 310 without materially damaging it. In yet another embodiment, the housing skin 310 is composed of a semirigid plastic and contoured such that it can be snapped in place over the bezel 210, perhaps wrapping around at least part of the user interface to secure it in place positively or frictionally. In still another embodiment, the housing skin 310 may wholly replace the bezel 210. In this embodiment, the bezel 210 is removed before the housing skin 310 is installed. Those skilled in the pertinent art are familiar with other materials and substances that may be employed to constitute the housing skin 310 and other techniques by which the housing skin may be mounted on or to the bezel 210 or the user interface.

In one embodiment, the second screen 330 is set to come on when the user interface is inactive for a predetermined period of time. In another embodiment, the second screen 330 is configured to come on upon an explicit user command, such as the press of a button (not shown). In still another embodiment, the second screen 330 is configured to come on upon the occurrence of one or more environmental conditions, such as particular temperatures or humidity levels.

FIG. 4 is a flow diagram of one embodiment of a method of providing an integrated screen/housing skin. The method begins in a start step 410. In a step 420, a housing skin is caused at least partially to surround a display of the user interface. In a step 430, a first screen is displayed on a display of the user interface that contains information regarding the HVAC system. In a step 440, a second screen is alternatively displayed on the display. The second screen matches the housing skin such that the housing skin and the second screen appear to form a cohesive image. The method ends in an end step 450.

Those skilled in the art to which this application relates will appreciate that other and further additions, deletions, substitutions and modifications may be made to the described embodiments.

What is claimed is:

1. A user interface for use with an HVAC system, comprising:
a display configured to provide information to a user;
a housing skin at least partially surrounding said display; and
a processor and memory coupled to said display and said touchpad and configured to drive said display, said display further configured alternatively to display a first screen containing information regarding said HVAC system and a second screen that matches said housing skin such that said housing skin and said second screen appear to form a cohesive image.

2. The user interface as recited in claim 1 wherein said housing skin is adhesively bonded to a bezel of said user interface.

3. The user interface as recited in claim 1 wherein said housing skin is contoured to allow said housing skin to be snapped in place over a bezel of said user interface.

4. The user interface as recited in claim 1 wherein said housing skin replaces a bezel of said user interface.

5. The user interface as recited in claim 1 wherein said display is further configured to display said second screen when said user interface is inactive for a predetermined period of time.

6. The user interface as recited in claim 1 wherein said display is further configured to display said second screen upon an explicit user command.

7. The user interface as recited in claim 1 wherein a pattern of said housing skin registers with a pattern of said second screen both horizontally and vertically.

8. A method of providing an integrated screen/housing skin for a user interface of an HVAC system, comprising:
causing a housing skin at least partially to surround a display of said user interface;
displaying a first screen on a display of said user interface that contains information regarding said HVAC system; and
alternatively displaying a second screen on said display that matches said housing skin such that said housing skin and said second screen appear to form a cohesive image.

9. The method as recited in claim 8 wherein said causing comprises adhesively bonding said housing skin to a bezel of said user interface.

10. The method as recited in claim 8 wherein said housing skin is contoured, said causing comprising snapping said housing skin in place over a bezel of said user interface.

11. The method as recited in claim 8 wherein said causing comprises replacing a bezel of said user interface with said housing skin.

12. The method as recited in claim 8 wherein said alternatively displaying comprises alternatively displaying said second screen when said user interface is inactive for a predetermined period of time.

13. The method as recited in claim 8 wherein said alternatively displaying comprises alternatively displaying said second screen upon an explicit user command.

14. The method as recited in claim 8 wherein a pattern of said housing skin registers with a pattern of said second screen both horizontally and vertically.

15. An HVAC system, comprising:
a heat pump or a compressor having at least one stage;
at least one condenser coil;
an expansion valve;
at least one evaporator coil;
a loop of pipe interconnecting said heat pump or compressor, said at least one condenser coil, said expansion valve and said at least one evaporator coil and containing a refrigerant;
at least one fan configured to cause outdoor air and indoor air to blow over said at least one condenser coil and said least one evaporator coil; and
a user interface, including:
a display configured to provide information to a user,
a housing skin at least partially surrounding said display, and
a processor and memory coupled to said display and said touchpad and configured to drive said display, said display further configured alternatively to display a first screen containing information regarding said HVAC system and a second screen that matches said housing skin such that said housing skin and said second screen appear to form a cohesive image.

16. The HVAC system as recited in claim 15 wherein said housing skin is adhesively bonded to a bezel of said user interface.

17. The HVAC system as recited in claim 15 wherein said housing skin is contoured to allow said housing skin to be snapped in place over a bezel of said user interface.

18. The HVAC system as recited in claim 15 wherein said housing skin replaces a bezel of said user interface.

19. The HVAC system as recited in claim 15 wherein said display is further configured to display said second screen when said user interface is inactive for a predetermined period of time.

20. The HVAC system as recited in claim 15 wherein said display is further configured to display said second screen upon an explicit user command.

21. The HVAC system as recited in claim 15 wherein a pattern of said housing skin registers with a pattern of said second screen both horizontally and vertically.

22. An HVAC user interface customization kit, comprising:
a precut housing skin configured to be coupled to a user interface and at least partially surround a display thereof; and
a picture configured to be transferred to said user interface and employed as a second screen that matches said housing skin such that said housing skin and said second screen appear to form a cohesive image.

23. The customization kit as recited in claim 22 wherein said housing skin is adhesively bonded to a bezel of said user interface.

24. The customization kit as recited in claim 22 wherein said housing skin is contoured to allow said housing skin to be snapped in place over a bezel of said user interface.

25. The customization kit as recited in claim 22 wherein said housing skin replaces a bezel of said user interface.
